(19) United States
(12) Patent Application Publication
(10) Pub. No.: US 2008/0163184 A1
(43) Pub. Date: Jul. 3, 2008

(54) System for creating parallel applications

(75) Inventor: Udayan Kanade, Pune (IN)

Correspondence Address: William L. Botjer, PO Box 478, Center Moriches, NY, 11934, US

(73) Assignee: CODITO TECHNOLOGIES, PUNE (IN)

(21) Appl. No.: 11/891,732

(22) Filed: Aug. 13, 2007

Related U.S. Application Data
(63) Continuation of application No. PCT/IN05/00046, filed on Feb. 15, 2005.

(51) Int. Cl. G06F 9/28

(52) U.S. Cl. 717/149

(57) ABSTRACT

A computer program product, a system, and a computer-implemented method for graphically designing, modeling, developing and debugging parallel applications are disclosed. The computer program comprises a program code for graphically modeling interactions between constituents of a parallel application, and generating a human-readable code for the interaction between the constituents. Interactions comprise semaphores. Changes can be made to the models of the parallel applications as well as the generated human-readable code. Complex parallel applications can be modeled by using the computer program product and data-processing system of the present invention. Further, the current state of the constituents can also be displayed on the models of the parallel applications and the generated human-readable code, to identify errors in the parallel application.

### REFERENCE TO RELATED APPLICATIONS

This application is a continuation, and claims priority, of PCT Patent Application PCT/IN2005/000046 filed Feb. 15, 2005.

This application is related to the following application which is hereby incorporated by reference as if set forth in full in this specification:

Co-pending U.S. patent application Ser. No. 10/667549, titled ‘Method and System for Multithreaded Processing Using Errands’, filed on Sep. 22, 2003.

Co-pending U.S. patent application Ser. No. 10/667756, titled ‘Method and System for Minimizing Thread Switching Overheads and Memory Usage in Multithreaded Processing’ filed on Sep. 22, 2003.

Co-pending U.S. patent application Ser. No. 10/667757, titled ‘Method and System for Allocation of Special-purpose Compute Resources in a Multiprocessor System’, filed on Sep. 22, 2003.

The present invention relates to the field of computer programming, and more specifically, to the field of visual programming languages.

### BACKGROUND

The present invention relates to the field of computer programming, and more specifically, to the field of visual programming languages.

A programming language is a notation for creating computer programs or applications. Many programming languages have been developed since the origination of computers. Each programming language has a syntax, which comprises a set of rules and conventions, according to which the programs are created. Programming languages may be classified on the basis of the type of programs they are used to create. Some languages are specifically designed for the purpose of creating mathematical or analytical programs. Examples of mathematical programming languages include A Mathematical Programming Language (AMPL) and MATLAB. Some programming languages are designed to create business or data-processing applications, extensible Markup Language (XML) and Structured Query Language (SQL) are examples of business or and data-processing programming languages. Some programming languages are general purpose, for example, Java and C++.

Programming languages may also be classified as textual programming and visual programming languages. Textual programming languages have a syntax comprising strings of text. Rules are defined with common language words such as ‘if, ‘then’, ‘while’, ‘print’, and the like. Java and C++ are examples of textual programming languages. On the other hand, the syntax of visual programming languages comprises figures and/or icons. These figures represent elements of the program and are connected or linked to represent the flow of data or control. Examples of visual programming languages include Visual Basic, Visual C++ and Prograph.

Though textual programming languages are widely used, they have some inherent disadvantages. The code for programs created using textual programming languages is a one-dimensional textual string, which does not show the connections between the constituents of a program. Further, errors in the text are difficult to isolate and correct. Visual programming languages represent the program and its constituents in two or even three dimensions. The interaction and flow of data between the constituents is shown graphically. Hence, visual programming languages visually depict the connections between the constituents of the program. The advantages of visual programming languages make them suitable for developing parallel applications.

Parallel applications use threads of execution, hereinafter referred to as threads, which are processes running or executing in parallel within the applications. In multiprocessor data-processing systems, threads run in parallel on different processors. The programmer creates threads for processes in the application that can run in parallel. For example, consider an application that needs to process data it receives from a network. The application can use a thread, to suspend execution until the data from the network is received, and simultaneously continue to process the received data.

There are several visual programming languages and systems for developing programs. One such system is described in U.S. Patent Publication No. 20040034846, titled ‘System, Method And Medium For Providing Dynamic Model-Code Associativity’, dated Feb. 19, 2004, and assigned to I-Logix Inc. This patent application relates to a system for dynamic model-code association between a model and a code for an application. This system allows programmers to create a model for the application, associate the elements of the model with a code, and then modify the model or the code. Changes made to the model are translated to changes in the code, and vice versa.

U.S. Pat. No. 6,684,385, titled ‘Program Object for Use in Generating Application Programs’, issued on Jan. 27, 2004, and assigned to SoftWIRE Technologies LLC, relates to a program development system that allows visual and textual development. Symbolic representations of control boxes (such as scroll bars and text boxes) are used to model an application. The symbols are linked together to represent the logical flow of data or control information passed between the symbols. The program development system then generates a code for the application.

Another graphical programming system is CODE, described in the paper titled ‘The CODE 2.0 Graphical Parallel Programming Language’ by James Newton and James C. Browne, and published in the proceedings of the ACM International Conference on Supercomputing in July 1992. CODE uses class hierarchies as a means of mapping logical program representations to executable program representations. CODE applications are modeled by using graphs, which are then automatically translated into code.

The programming languages and environments described above provide substantial advantages over textual programming languages. However, these languages and environments do not provide a complete solution for designing, modeling, debugging and reverse engineering of a parallel application.

From the above discussion, it is evident that there is a need for a system that enables a programmer to design, model, debug and reverse engineer parallel applications. The system should be able to convert the model for the parallel application to a code. Further, the system should be able to convert the code for a parallel application to a model. The system should also allow debugging of the parallel application.

### DISCLOSURE OF THE INVENTION

### Summary

The present disclosure is directed at a computer program product and a system that enables a programmer to create a parallel application.

An aspect of the disclosure is to provide a system to design, diagram, develop and debug a parallel application.

Another aspect of the disclosure is to enable a programmer to model interactions between the constituents of a parallel application.

Yet another aspect of the disclosure is to provide a system that generates a model from a computer-readable code and allows a programmer to alter this generated model.

In one embodiment the computer program product of the present invention comprises a computer-readable code for modeling the interaction between the constituents of the parallel application. The constituents of the parallel application comprise threads. Further, the computer program product generates a computer-readable code for the interaction between the constituents of the parallel application. The system of the present invention comprises a modeler for modeling the interaction between the constituents of the parallel application, and a code generator for generating a computer-readable code for the interaction between the constituents of the parallel application.

The invention described above offers many advantages. It can be used for developing complex multithreaded applications. Developing multithreaded applications is made simpler by means of the present invention, as compared to coding the multithreaded applications in textual programming languages. Further, the invention is flexible enough to model a large set of interactions. Representations of the new constituents of parallel applications can be added. The code generator can be modified so that code for the new constituents can also be generated.

The present invention is based on the standard thread-semaphore paradigm and can therefore be easily learned and used by programmers.

The interactions between the threads can be visualized. Further, the purpose of each thread can be understood, as the thread line is a diagrammatic representation of the code for the thread. The interaction between the thread and other threads can also be understood.

In the interaction between the threads, bugs can be identified with the help of a debugger. The current state of the parallel application is represented visually by using labels, colors or icons. A programmer can identify the bugs by viewing the current state of the parallel application, and remove the bugs from the parallel application.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a block diagram illustrating a data-processing system, in accordance with an embodiment of the present invention;

FIG. 2 is a block diagram illustrating a modeler, in accordance with an embodiment of the present invention;

FIG. 3 is a block diagram illustrating a representation of a thread;

FIG. 4A is a block diagram illustrating a representation of a thread with a loop;

FIG. 4B is a block diagram illustrating a representation of a thread with a condition;

FIG. 4C is a block diagram illustrating a representation of a thread with multiple conditions;

FIG. 4D is a block diagram illustrating a representation of a thread array;

FIG. 5 is a block diagram illustrating an interaction between two threads by using semaphores;

FIG. 6 is a flowchart illustrating the working of a code generator;

FIG. 7 is a block diagram illustrating a representation of a thread that is posting and waiting for semaphores;

FIG. 8 is a block diagram illustrating a multiprocessor data-processing system on which a parallel application, created with the help of the present invention, executes;

FIG. 9 is a block diagram illustrating a data-processing system for identifying bugs in a parallel application; and

FIG. 10 is a block diagram illustrating a label that displays information about a thread.

### DESCRIPTION OF EMBODIMENTS

The present disclosure relates to a visual programming language for creating parallel applications. Constituents of parallel applications are shown as representations, and the representations and interactions between the constituents are graphically modeled. A human-readable code for the interactions is then automatically generated.

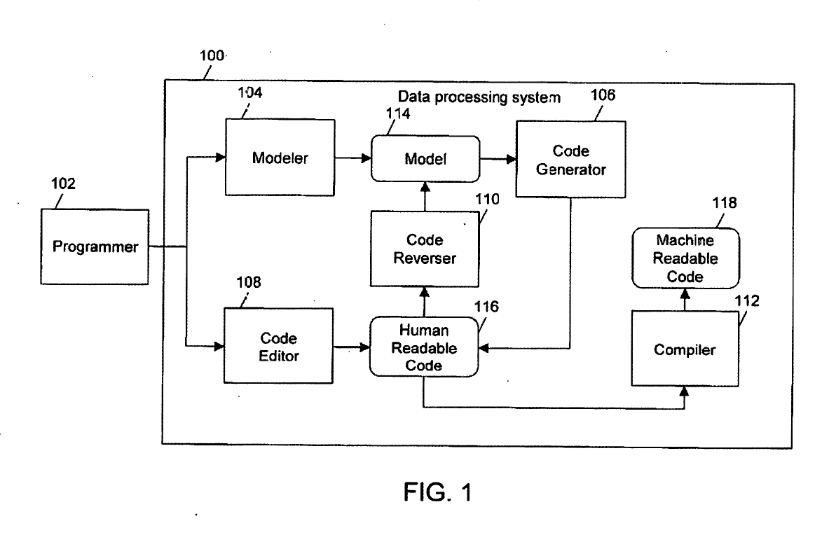

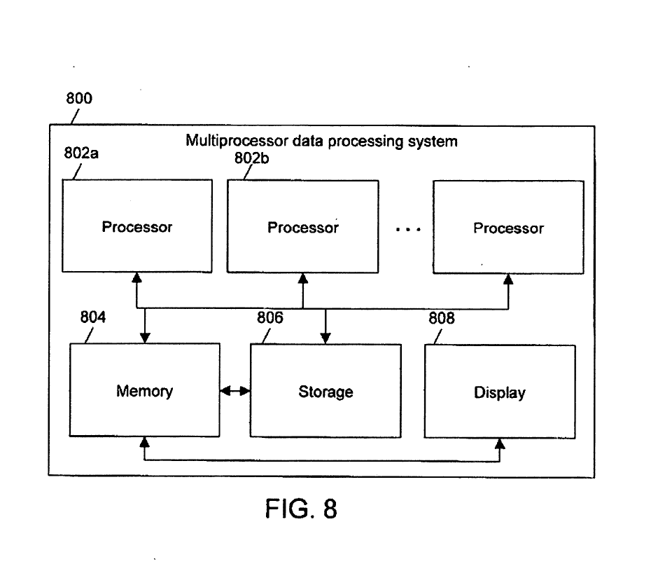

FIG. 1 shows a data-processing system 100, in accordance with an embodiment of the present invention. A programmer 102 uses software running on data-processing system 100, to create parallel applications. A parallel application comprises threads of execution, hereinafter referred to as threads. Threads are processes that are running or executing concurrently within the parallel application. In multiprocessor data-processing systems, threads run in parallel on different processors. Programmer 102 identifies which processes of the parallel application may execute in parallel, and creates threads corresponding to these processes. The threads execute concurrently on the processors of multiprocessor data-processing systems. Multiprocessor data-processing systems are explained later in conjunction with FIG. 8.

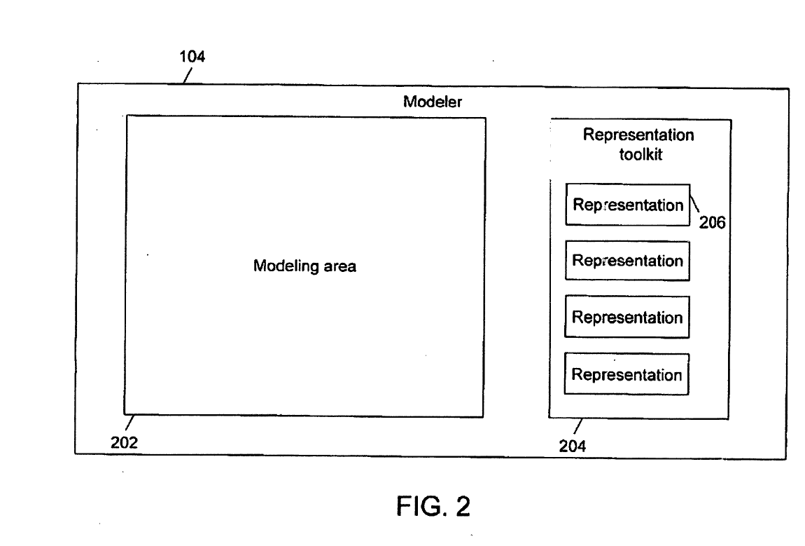

Data-processing system 100 comprises a modeler 104, a code generator 106, a code editor 108, a code reverser 110, and a compiler 112. It will be apparent to those skilled in the art that modeler 104, code generator 106, code editor 108, code reverser 110 and compiler 112 are software modules running on data-processing system 102. Modeler 104 is used to create a model 114 or a diagram for the parallel application. Modeler 104 is explained later in conjunction with FIG. 2. Code generator 106 generates a human-readable code 116 for the modeled parallel application. Code editor 108 is used to modify human-readable code 116 generated by code generator 106. Code reverser 110 changes model 114 so that any changes made in human-readable code 116 are shown in model 114. Compiler 112 compiles human-readable code 116 to machine-readable code 118. Model 114, human-readable code 116, and machine-readable code 118 are represented as rounded rectangles, to differentiate them from software modules in data-processing system 100.

FIG. 2 is a schematic representation of modeler 104. Modeler 104 comprises a modeling area 202 and a representation toolkit 204. Representation toolkit 204 further comprises a plurality of representations or buttons representing constituents of parallel applications, for example, a representation 206 is used to create a thread. In one embodiment of the present invention, parallel applications are created by using a drag-and-drop interface. Therefore, to model a thread, a representation 206 is dragged into work area 202, using a mouse pointer. It will be apparent to those skilled in the art that a click and place interface can also be used to model parallel applications. In a click and place interface, a representation is clicked and then is placed into modeling area 202 by clicking on an appropriate position.

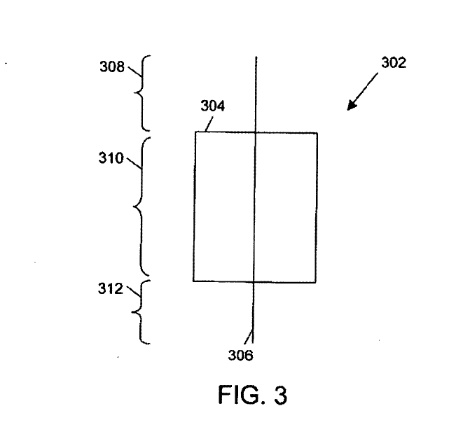

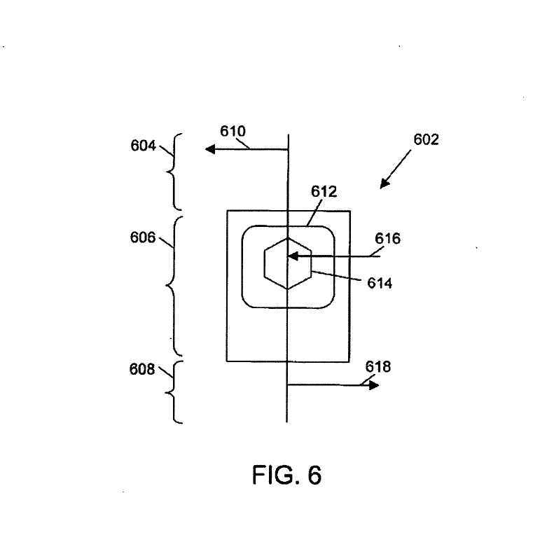

FIG. 3 is a block diagram of a representation for a thread, in accordance with an embodiment of the present invention. A thread 302 is represented as a box 304 with a thread line 306 going through box 304. Box 304 represents an infinite loop within thread 302. Thread line 306 represents the flow of control or the sequence of execution within thread 302. The flow of control is from the top of thread line 306 towards the bottom. Thread 302 comprises three portions, 308, 310 and 312. Portion 308 comprises operations performed before thread 302 enters the infinite loop. Portion 310 comprises operations performed during the infinite loop. Operations performed after the infinite loop are included in portion 312. The portions of a thread are described later in conjunction with FIG. 6.

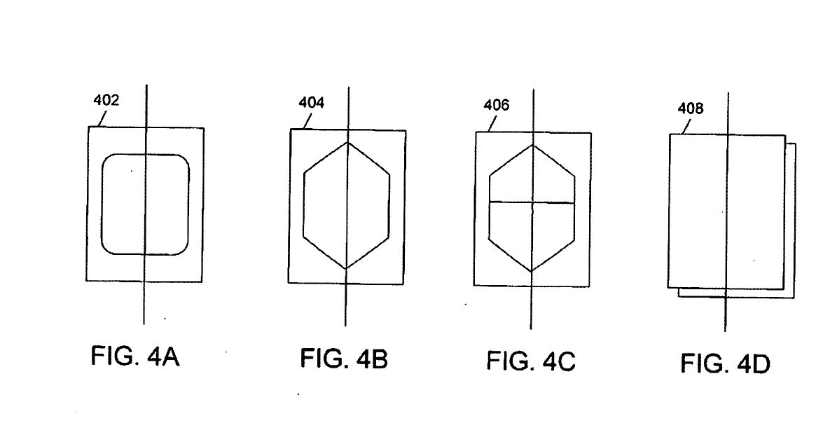

FIG. 4A, FIG. 4B, FIG. 4C, and FIG. 4D are block diagrams of representations of different types of threads that can be modeled in modeler 104. FIG. 4A shows a representation 402 for a thread that comprises a loop, which is represented by a rounded rectangle. This means that the part of the thread that is inside the rounded rectangle executes repeatedly for a specified number of times, or until a predefined condition is met. FIG. 4B shows a representation 404 for a thread that comprises a condition, which is represented by a hexagon. This means that the part of the thread that is inside the hexagon executes only if a predefined condition is met. FIG. 4C shows a representation 406 for a thread that comprises multiple conditions, which are represented by a hexagon with more than one line cutting the thread line representing the flow of control of representation 406. FIG. 4D shows a representation 408 for a thread array, which is represented by another box behind the box representing the infinite loop of representation 408. A plurality of threads that perform a similar function can be represented by using a thread array, for example, if a set of threads is responsible for obtaining data from a plurality of data sources such as databases, they can be represented as a thread array.

Threads created by utilizing the present invention can be optimized by using itinerary or floating thread methodologies. In the itinerary thread methodology, a thread is broken up into a series of small tasks, referred to as errands. The errands execute with the help of an operating system. A series of errands execute in an order defined by an itinerary, which minimizes thread switching overheads and reduces memory usage. The itinerary thread methodology is described in detail in co-pending U.S. patent application Ser. No. 10/667549, titled ‘Method and System for Multithreaded Processing Using Errands’ filed on Sep. 22, 2003 which is hereby incorporated herein by reference. In the floating thread methodology, threads are compiled in such a way that they require less memory in the multiprocessor data-processing system on which the threads execute. The floating thread methodology is described in co-pending U.S. patent application Ser. No. 10/667756, titled ‘Method and System for Minimizing Thread Switching Overheads and Memory Usage in Multithreaded Processing’, filed on Sep. 22, 2003, which is hereby incorporated herein by reference.

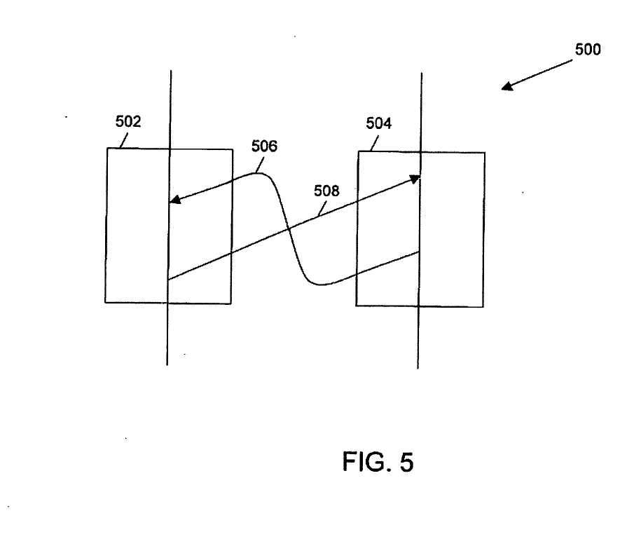

Interactions between the constituents of the parallel application are also modeled in modeler 104. FIG. 5 is a schematic representation of the interaction between two threads, thread 502 and thread 504. The interaction between threads 502 and 504 comprises two semaphores, semaphore 506 and semaphore 508. Semaphores are used to signal the completion of a thread and to control access to a shared resource that can support access only from a limited number of threads. Examples of a shared resource include a thread and a data source. A semaphore maintains a counter that indicates the number of threads accessing the shared resource. Each time a thread tries to access the shared resource, the value of the counter of a semaphore reduces by one. The request to access a shared resource is referred to as a ‘wait¹. When a thread completes accessing a shared resource, also referred to as a ‘post’, the counter increases by one. When the value of the counter is zero, the shared resource cannot be accessed by any other thread.

In an embodiment of the present invention, semaphores are represented as arrows, as shown in FIG. 5. The arrowhead of semaphore 506 represents a semaphore wait, and the tail of the arrow represents a semaphore post. FIG. 5 shows a model 500 for a solution to a producer-consumer problem created in modeling area 202. In a producer-consumer relation, a producer waits for a consumer to ask for a product, and then produces it. The consumer accepts the product and consumes it. After consuming it, the consumer asks the producer to produce another product, and waits for the producer to produce it, thereby setting up a loop. The producer-consumer problem may be used to model a parallel application. A first thread processes data and sends the output of the processing to a second thread. The second thread processes the output and signals the end of processing to the first thread. Hence, the first thread can be called a producer thread and the second thread a consumer thread. In the model, as shown in FIG. 5, thread 502 is the producer thread and thread 504 is the consumer thread. Semaphore 506 indicates that thread 502 waits for thread 504. When thread 504 completes execution, it signals this by posting semaphore 506. Similarly, semaphore 508 indicates that thread 504 is also waiting for thread 502.

A semaphore may also be posted by other constituents of the parallel application. Other constituents of parallel applications include device drivers. For example, a device driver may post a semaphore to a thread. Further, a thread may also post a semaphore to a device driver. A semaphore array can be posted by one thread to a plurality of constituents. For example, one thread may require data from a plurality of databases. The thread then posts a semaphore array, comprising a plurality of semaphores, to the plurality of databases. Appropriate representations of device drivers, semaphore arrays, and the like, can be included in representation toolkit 204.

Modeler 104 can also be used to model other parallel application constituents, for example, if the parallel application accesses a device such as a network interface or a modem, or a source of data on a different computer such as a database. In that event, a device driver that is used to access the database is modeled by using representations. Therefore, a device driver representation is provided in representation toolkit 204. A device driver is a component of an operating system that defines the interaction between the computer on which the operating system executes and an external device such as a modem, a printer, or another computer. Buffers may also be modeled in modeler 104 by using representations. Buffers are portions of memory of a computer system, used to communicate data between threads. The execution of certain threads may be optimal on special-purpose processors. Therefore, it is advantageous to ensure that the threads execute on these special-purpose processors only. This is referred to as special purpose processor allocation. Representations of special purpose processor allocation can also be modeled by using modeler 104. A method for special purpose processor allocation is described in co-pending U.S. patent application Ser. No. 10/667757, titled ‘Method and System for Allocation of Special-purpose Compute Resources in a Multiprocessor System’, filed on Sep. 22, 2003, which is hereby incorporated herein by reference.

### BEST MODE FOR CARRYING OUT THE INVENTION

In an embodiment of the present invention, code generator 106 creates a computer-readable code on the basis of the diagram created in work area 202. Code generator 106 can create a computer-readable code in any imperative programming language. Exemplary imperative languages include Java, C, C++, Pascal and assembly language. For example, the human-readable code for representation 402 (as shown in FIG. 4A) is:

Thread 402( )
{

for(;;)

}
for(number of loops)
{
// operations to be performed within the loop }
}

}

}

In the above code, text following two slashes (//) represents comments that are ignored while the parallel application is compiled by compiler 112. Operations can be defined in the loop represented in representation 402.

The human-readable code for representation 404 in FIG. 4B is:

Thread 402( )
{

for(;;)
{

if(condition)
{
// operations to be performed if condition is met
}

}

}

Similarly, the human-readable code for the interaction between threads 502 and 504 is:

Thread 502 ( )
{

for(;;) //starting of infinite loop
{

wait(semaphore 506);
post(semaphore 508);

} //end of infinite loop

}
Thread 504 ( )
{

for(;;) //starting of infinite loop
{
wait(semaphore 508);
post(semaphore 506);
} //end of infinite loop

}

It will be apparent to those skilled in the art that the function names generated in the code given above correspond to function names in programming languages such as C++ and Java. However, other function names are generated when codes are generated in other languages. Here, function Thread 502 ( )′ includes the computer-readable code for thread 502, and function Thread 404 ( )′ includes the computer-readable code for thread 504. It will be apparent to those skilled in the art that code generator 106 may generate a computer-readable code for other interactions between the threads. Further, code generator 106 can automatically provide names for the interactions. These names can then be changed by programmer 102, while viewing human-readable code 116, or by defining the properties of the interactions within modeling area 202.

An example of a representation of a thread posting and waiting for semaphores is shown in FIG. 6. A thread 602 comprises three portions, 604, 606 and 608. In portion 604, i.e., before entering the infinite loop, thread 602 posts semaphore 610. Portion 606, i.e., the infinite loop, comprises loop 612, which is represented by a rounded rectangle. Loop 612 further comprises a condition 614, which is represented by a hexagon. If execution enters condition 614, thread 602 waits for semaphore 616. In portion 608, i.e., after exiting the infinite loop, thread 602 posts a semaphore 618. The human-readable code for thread 602 is:

Thread 602 ( )
{

//start of portion 604
post(semaphore 610);
//end of portion 604
for(;;) //start of portion 606, i.e., infinite loop
{

for (number of iterations) //starting of loop 612
{

if(condition) //starting of condition 614
{
wait(semaphore 616);

}

}

} //end of portion 606
//start of portion 608
post(semaphore 618);
//end of portion 608
}

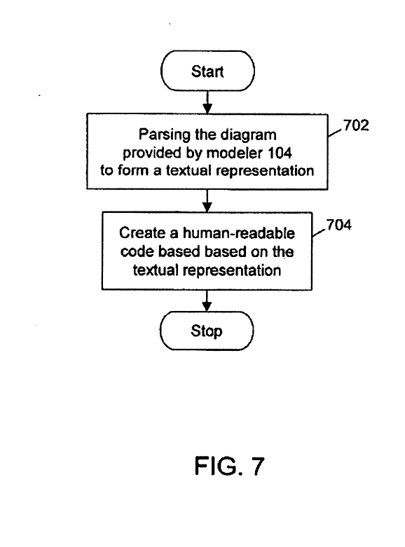

FIG. 7 is a flowchart illustrating the working of code generator 106, in accordance with an embodiment of the present invention. Modeler 104 provides the diagram to code generator 106. Code generator parses the diagram at step 702. In an embodiment of the present invention, code generator 106 parses the diagram by identifying the representations of the components of the parallel application in the diagram, and creating a textual representation of the diagram. For example, an exemplary textual representation of representation 402 as shown in FIG. 4A, is as follows:

Start thread line Start thread rectangle Start loop rounded rectangle End loop rectangle End thread rectangle End thread line.

It will be apparent to those skilled in the art that this textual representation is created by traversing the representation vertically along the thread line. After creating the textual representation, code generator 106 creates a human-readable code for the parallel application at step 704. The human-readable code is based on the textual representation and is in a programming language as desired by programmer 102.

Code editor 108 is an interface in which programmer 102 can view, modify or add to human-readable code 116 generated by code generator 106. In an embodiment, code editor 108 is shown when programmer 102 clicks on a constituent of the parallel application that is being developed in modeling area 202. For example, to modify or add to human-readable code 116 for thread 502 (as shown in FIG. 5), programmer 102 clicks on thread 502 in work area 202. Code editor 108 then shows the generated human-readable code 116 for thread 502. After adding human-readable code for thread 502, the function, Thread 502 ( ), may appear as:

Thread 502 ( )
{

for(;;)
{

wait(semaphore 506);
result = process (input);
store(result);
post(semaphore 508);

}

}

After waiting for semaphore 506, the input to thread 502 is processed and the results of the processing are stored in a temporary buffer for thread 504 to read. It will be apparent to those skilled in the art that the results of the processing can also be stored in a variable called result, for thread 504 to read. Further, the value of the result can also be stored in a permanent storage such as a hard disk. Semaphore 508 is posted after the storage.

It will be apparent to those skilled in the art that programmer 102 can also instruct code editor 108 to display the entire computer-readable code for the parallel application.

In another embodiment of the present invention, programmer 102 provides human-readable code 116 for a parallel application, and model 114 for the provided computer-readable code is created by code reverser 110. Consider a case where programmer 102 provides the following human-readable code:

Thread 502 ( )
{

for(;;)
{

wait(semaphore 506);
post(semaphore 508);
}

}
Thread 504 ( )
{

for(;;)
{

wait(semaphore 508);
post(semaphore 506);
}

}

Since this is the code for the producer-consumer problem, as discussed above, the corresponding model created by code reverser 110 is the same as that shown in FIG. 5. This model appears in modeling area 202. Code reverser 110 creates the model by parsing human-readable code 116, resulting in a parse tree being generated. The parse tree, which is a hierarchical representation of the elements of human-readable code 116, is then converted to the model by using representations. Code reverser 110 ignores whatever cannot be represented in modeler 104, for example, variables. Further, programmer 102 can add constituents of the parallel application, using modeler 104. Human-readable code 116 for the added constituents is generated by code generator 106. Programmer 102 can also view and modify human-readable code 116 by using code editor 108.

After modeling, code generation and editing of the parallel application has been completed, human-readable code 116 is compiled by compiler 112 into machine-readable code 118. Machine-readable code 118 is in the form of machine language that can be executed by a multiprocessor data-processing system. Parallel programs, created with the help of the present invention, can execute on a multiprocessor data-processing system. FIG. 8 is a block diagram illustrating a multiprocessor data-processing system 800 on which the parallel application can execute. Multiprocessor data-processing system 800 comprises a plurality of processors 802, a memory 804, and a storage 806. In an embodiment of the present invention, storage 806 is a hard disk. Multiprocessor data-processing system 800 may further comprise a display 808. In an embodiment of the invention, display 808 is a monitor. Memory 804 contains machine-readable code 118, which is generated after compilation. Plurality of processors 802 read the computer-executable code from memory 804 and execute the computer-executable code. It will be apparent to those skilled in the art, that processors 802a, 802b, etc., may be present on different computers and not on one multi-processor computer, as described above.

The threads of the parallel application execute on the different processors of multiprocessor data-processing system 800 concurrently, for example, in the producer-consumer problem described with the help of FIG. 5, thread 502 can execute on a processor 802a and thread 504 can execute on a processor 802b of multiprocessor data-processing system 800. The execution of the threads is controlled by an operating system that also executes on multiprocessor data-processing system 800. Exemplary operating systems that may execute on multiprocessor data-processing system 800 include UNIX, Linux and Windows NT™.

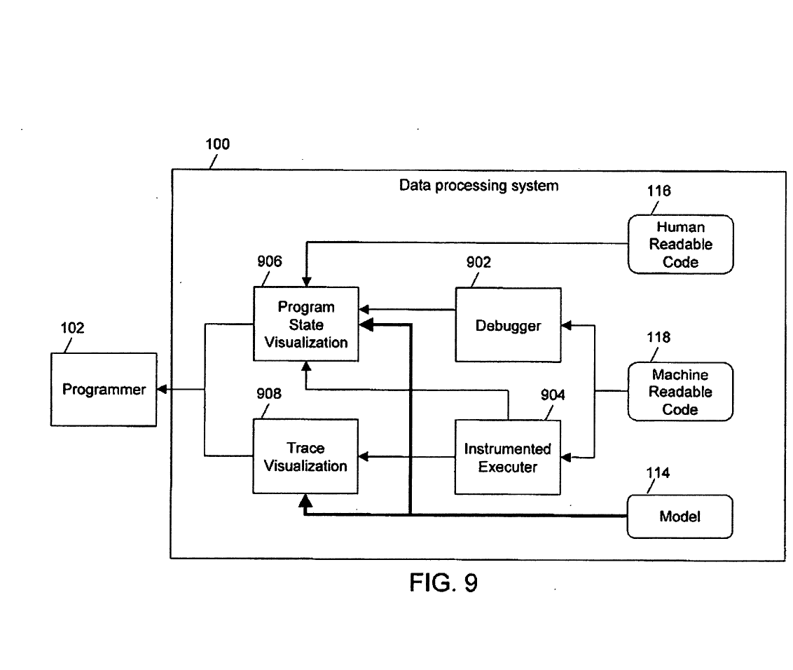

Errors or ‘bugs’ may exist in the parallel application that may cause unexpected results during execution. Hence, the parallel application is debugged, to identify the errors. FIG. 9 is a block diagram detailing a data-processing system for identifying bugs in a parallel application. As shown in FIG. 9, data-processing system 100 is used to identify bugs in the parallel application. It will be apparent to those skilled in the art that a separate data-processing system can be used to identify the bugs. Data-processing system 100 further comprises a debugger 902, an instrumented executer 904, a program state visualization 906, and a trace visualization 908. Debugger 902 detects the current state of the parallel application. Instrumented executer 904 is a special operating system that runs machine-readable code 118 and generates traces for the parallel application. Program state visualization 906 shows the state of the parallel application to programmer 102. Trace visualization 908 shows the timeline charts of processor or thread activities to programmer 102. It will be apparent to those skilled in the art that debugger 902, instrumented executer 904, program state visualization 906 and trace visualization 908 are software modules running on data-processing system 100. Inputs from model 114 to program state visualization 906 and trace visualization 908 are depicted as thick arrows, to differentiate them from inputs to machine-readable code 118.

Instrumented executer 904 is a special operating system that logs all pertinent information about pertinent events such as trace data. Pertinent events pertaining to parallel applications include the beginning of the execution of a thread on a processor, postings of semaphores, changes in values of variables, the idle times of processors, etc. Other information that is necessary for debugger 902 is also logged. Pertinent information regarding these events include the times of occurrence, the number of times that an event has occurred, changes in the values of variables, etc. These logs can be per event type (i.e., a log for each type of event that occurs), per processor type (i.e., a log for each processor running the various threads of the parallel application), or per semaphore type (i.e., a log for every semaphore). It will be apparent to those skilled in the art that a single log can be generated for the parallel application.

In one embodiment of the present invention, machine-readable code 118 is executed by instrumented executer 904. Debugger 902 detects the current state of execution of machine-readable code 118. The current state is shown to programmer 102 with the help of program state visualization 906. The inputs to program state visualization 906 are the current state of each of the threads in the parallel application, as detected by debugger 902, model 114, and human-readable code 116. Therefore, program state visualization 906 shows the state of the parallel application on model 114 and in human-readable code 116. Programmer 102 can see this state and use it to remove the bugs in the parallel application. This method of debugging is referred to as live debugging.

In another embodiment of the present invention, debugging is carried out after the parallel application executes. This method is referred to as replay debugging. Here, instrumented executer 904 generates and stores trace data during the execution of machine-readable code 118. This trace data is shown to programmer 102 with the help of trace visualization 908. The inputs to trace visualization 908 include trace data, model 114, and human-readable code 116. Therefore, trace visualization 908 shows the state of the parallel application on model 114 and in human-readable code 116. Trace visualization 908 can present this log as timeline charts and animations. Timeline charts represent pertinent information pertaining to the constituents of the parallel application with respect to time, and can also present processor, process, or semaphore activities. Timeline charts also comprise information on the time of the change of states of threads (ready, running or blocked). Similarly, animations showing pertinent information on model 114 can also be presented.

Debugger 902 halts the execution of machine-readable code 118 under specified conditions. The specified conditions include the line number of human-readable code 116 and the values of specific variables or expressions within machine-readable code 118. The line numbers or values at which debugger 902 stops execution are sent to program state visualization 906, which displays them to programmer 102 along with state of the parallel application on model 114 or human-readable code 116.

Labeling, coloring or icons are used to indicate the information obtained by program state visualization 906 and trace visualization 908. Labels are boxes shown next to the constituents of the parallel application in modeler 104 or code editor 108. For example, a label next to a thread can indicate the processor on which the thread is executing. A label next to a semaphore can indicate the value of the counter of the semaphore. If a semaphore is waiting for a thread array, a label can also indicate the particular thread of the thread array for which the semaphore is waiting. The line number of human-readable code 116 causing an error can also be indicated in a label next to the constituent, which corresponds to human-readable code 116. The state of a thread can also be indicated by using labeling. For example, a thread may be labeled as ready, blocked or running, based on its state. A thread is ready when it is waiting to begin execution. It is blocked if the counter of the semaphore it is waiting for is zero. Further, while debugging, a thread can be ‘clicked’ on, to move the debugging to that thread. It will be apparent to those skilled in the art that colors can also be used to indicate the information obtained from debugger 114. For example, different color representations can be used to indicate the state of the threads.

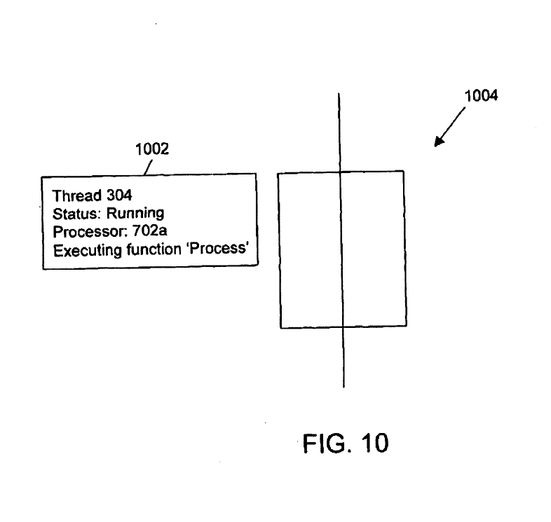

FIG. 10 is a block diagram illustrating a label 1002, which displays information pertaining to thread 1004. Label 1002 shows that the status of thread 1004 is ‘running’, i.e., thread 1004 is executing on processor 802a. Further, label 1002 also indicates that thread 1004 is currently executing a function called ‘process’ that is defined in human-readable code 116. It will be apparent to those skilled in the art that other constituents of a parallel application such as semaphores can also be labeled in a similar manner.

The data-processing system, as described in the present disclosure, or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the like. The computer further comprises a microprocessor. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device, which enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

The invention described above offers many advantages. It can be used to develop complex multithreaded applications. Developing multithreaded applications is simpler with the present invention, as compared to coding the multithreaded applications in textual programming languages. Further, the invention is flexible enough to model a large set of interactions. Representations of new constituents of parallel applications can also be added. The code generator can be modified so that a code for the new constituents can also be generated.

The present invention is based on the standard thread-semaphore paradigm and can therefore be easily learnt and used by programmers.

The interactions between the threads can be visualized. Further, the purpose of each thread can be understood, as the thread line is a diagrammatic representation of the code for the thread. The interaction between the thread and other threads can also be understood.

In the interaction between the threads, bugs can be identified with the help of the debugger. The current state of a thread is represented visually by using labels, colors or icons. A programmer can identify the bugs and remove them from the parallel application.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A computer program product for use with a computer, the computer program product comprising a computer usable medium having a computer readable code embodied therein for creating a parallel application, the parallel application comprising a plurality of threads, the computer program product performing the steps of:
a. graphically modeling interaction between the plurality of threads; and
b. generating a first human readable code for the interaction between the plurality of threads.

2. The computer program product of claim 1 further performing the step of representing the plurality of threads as at least one representation.

3. The computer program product of claim 1 wherein the interaction between the plurality of threads comprises at least one semaphore.

4. The computer program product of claim 1 further performing the step of modeling a second human readable code.

5. The computer program product of claim 1 further performing the step of editing the generated first human readable code.

6. The computer program product of claim 1 further performing the step of compiling the first human readable code to machine readable code.

7. The computer program product of claim 1 further performing the steps of executing the parallel application and generating trace data for the parallel application.

8. The computer program product of claim 1 further performing the step of debugging the parallel application.

9. The computer program product of claim 1 further performing the step of labeling the interaction between the plurality of threads.

10. A computer program product for use with a computer, the computer program product comprising a computer usable medium having a computer readable code embodied therein for creating a parallel application, the parallel application comprising a plurality of threads, the computer program product performing the steps of:
a. graphically modeling interaction between the plurality of threads, the interaction comprising at least one semaphore, wherein the plurality of threads is represented as at least one representation;
b. generating a first human readable code for the interaction between the plurality of threads;
c. editing the generated first human readable code;
d. compiling the first human readable code in to machine readable code;
e. debugging the parallel application; and
f. labeling the interaction between the plurality of threads.

11. The computer program product of claim 10 further performing the step of modeling a second human readable code.

12. The computer program product of claim 10 further performing the step of generating trace data for the parallel application.

13. A data processing system for creating a parallel application, the parallel application comprising a plurality of threads, the system comprising:
a. a modeler, the modeler graphically modeling interaction between the plurality of threads; and
b. a code generator, the code generator generating a first human readable code for the interaction between the plurality of threads.

14. The data processing system of claim 13 wherein the plurality of threads is represented as at least one representation.

15. The data processing system of claim 13 wherein the interaction between the plurality of threads comprises at least one semaphore.

16. The data processing system of claim 13 further comprising a code editor, the code editor editing the generated first human readable code.

17. The data processing system of claim 13 further comprising a code reverser, the code reverser creating a model from a second human readable code.

18. The data processing system of claim 13 further comprising a compiler, the compiler compiling the first human readable code in to machine readable code.

19. The data processing system of claim 13 further comprising a debugger, the debugger identifying bugs in the parallel application.

20. The data processing system of claim 13 further comprising an instrumented executer, the instrumented executer executing the parallel application and generating trace data.

21. The data processing system of, claim 20 further comprising a trace visualization, the trace visualization displaying the trace data.

22. The data processing system of claim 13 further comprising a program state visualization displaying state of the plurality of threads and the interactions between the threads.

23. The data processing system of claim 13 wherein the interaction between the plurality of threads is labeled.

24. A computer implemented method for creating parallel applications, the parallel applications comprising a plurality of threads, the method comprising the steps of:
a. graphically modeling interaction between the plurality of threads; and
b. generating a first human readable code for the interaction between the plurality of threads.

25. The computer implemented method of claim 24 further comprising the step of representing the plurality of threads as at least one representation.

26. The computer implemented method of claim 24 wherein the interaction between the plurality of threads comprises at least one semaphore.

27. The computer implemented method of claim 24 further comprising the step of modeling a second human readable code.

28. The computer implemented method of claim 24 further comprising the step of editing the generated first human readable code.

29. The computer implemented method of claim 24 further comprising the step of compiling the first human readable code to machine readable code.

30. The computer implemented method of claim 24 further performing the steps of executing the parallel application and generating trace data.

31. The computer implemented method of claim 24 further comprising the step of debugging the parallel application.

32. The computer implemented method of claim 24 further comprising the step of labeling the interaction between the plurality of threads.
